(19) United States
(12) Patent Application Publication
(10) Pub. No.: US 2006/0110058 A1
(43) Pub. Date: May 25, 2006

(54) METHOD AND APPARATUS FOR LUMINANCE/CHROMINANCE (Y/C) SEPARATION

(76) Inventor: Po-Wei Chao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,317

(22) Filed: Nov. 17, 2005

(30) Foreign Application Priority Data
Nov. 19, 2004 (TW) 093135778

(51) Int. Cl. G06K 9/36

(52) U.S. Cl. 382/233

(57) ABSTRACT

A method for separating luminance (Y) and chrominance (C) of a composite video signal, the method includes: performing a motion detection on a target location of a target field; performing a motion detection on at least one reference location; and if image of the reference location and the target location are determined to have no motion, performing an inter-field Y/C separation on image signals of the target location.

### BACKGROUND OF THE INVENTION

1. Field of the Invention

The present invention relates to image processing techniques, and more particularly, to luminance/chrominance (Y/C) separation method and apparatus.

2. Description of the Prior Art

In composite video signals, luminance signals (Y) and chrominance signals (C) are transmitted within the same carrier. Accordingly, when a television receives the composite video signals, it needs to separate the luminance signals and the chrominance signals. This operation is also referred to as Y/C separation.

Generally, a conventional Y/C separator is to simply decide a suitable Y/C separation process for image signals of a target location of a current field according to a current motion detecting result of the target location of the current field. If the image of the target location is detected to have motion, the conventional video decoder utilizes a 1D or 2D comb filter to perform a Y/C separation on the image signals of the target location. Conversely, if the image of the target location is detected as still, a 3D comb filter is employed to perform a Y/C separation on the image signals of the target location. Typically, the 1D comb filter performs a low-pass filtering on a current scan line of the current field; the 2D comb filter averages pixel values of two corresponding scan lines of the current field; and the 3D comb filter averages pixel values of the current scan line of the current field and pixel values of a corresponding scan line of another field.

If the conventional video decoder erroneously determines the motion area or pixel, the resulting image quality will be deteriorated. The Y/C separation performance of the video decoder is quite restricted by the motion detection accuracy. However, the operational complexity and hardware costs are increased with the accuracy of the motion detection mechanism.

### SUMMARY OF THE INVENTION

It is therefore an objective of the claimed invention to provide a Y/C separation method to solve the above-mentioned problems.

According to an exemplary embodiment of the present invention, a method for separating Y/C of a composite video signal is disclosed comprising: performing a motion detection on a target location of a target field; performing a motion detection on at least one reference location; and if the reference location and the target location are determined to have no motion, performing an inter-field Y/C separation on image signals of the target location.

According to the exemplary embodiment of the present invention, a Y/C separating apparatus is disclosed comprising: a motion detector for performing motion detection on a target location of a target field and on at least one reference location; a decision unit for generating a control signal according to the detection results of the target location and the reference location; and a Y/C separation module comprising an inter-field separation unit and an intra-field Y/C separation unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a Y/C separating device in a video decoder according to an exemplary embodiment of the present invention.

FIG. 2 is a schematic diagram of video data.

FIG. 3 is a flowchart illustrating a Y/C separation method according to an exemplary embodiment of the present invention.

### DETAILED DESCRIPTION

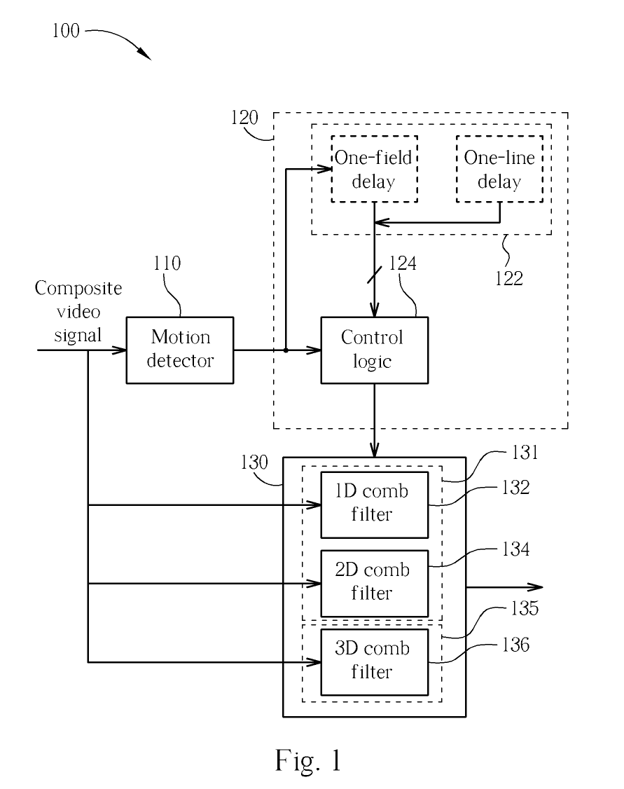

FIG. 1 illustrates a block diagram of a Y/C separating device 100 for use in a video decoder according to an embodiment of the present invention. The Y/C separating device 100 comprises a motion detector 110, a decision unit 120, and a filter module 130. The motion detector 110 performs motion detections on the received composite video signals on a pixel-by-pixel basis. The decision unit 120 is used for controlling the filter module 130 to perform corresponding Y/C separation according to detection results of the motion detector 110. In another embodiment, the apparatus 100 further comprises a Y/C separation filter (de-composite unit) receives a composite video signal and outputs Y signal or C signal to the motion detector 130.

In one embodiment of the present invention, the decision unit 120 comprises a buffer 122 and a control logic 124. The buffer 122 is used for temporarily storing the detection results obtained by the motion detector 110. In another embodiment, the filter module 130 comprises an inter-field Y/C separator 135 and an intra-field Y/C separator 131.

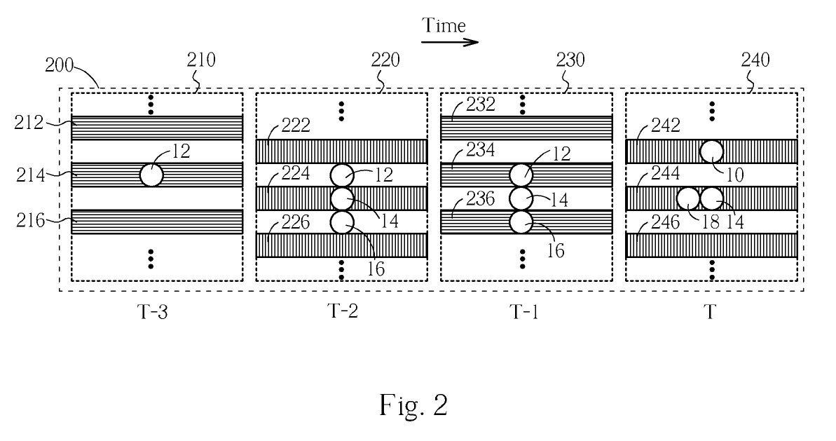

FIG. 2 is a schematic diagram of video data 200 of the composite video signal received by the Y/C separating device 100. The video data 200 comprises four consecutive fields 210, 220, 230 and 240 corresponding to times T-3, T-2, T-1 and T, respectively. In FIG. 1, scan lines 212, 222, 232 and 242 are respectively the (N−1)th scan lines of fields 210, 220, 230 and 240; scan lines 214, 224, 234 and 244 are respectively the Nth scan lines of fields 210, 220, 230 and 240; and scan lines 216, 226, 236 and 246 are respectively the (N+1)th scan lines of fields 210, 220, 230 and 240. In the following description, the Y/C separation on image signals of a target location 14 of a target field 240 is employed as an example to describe the Y/C separation method of the present invention.

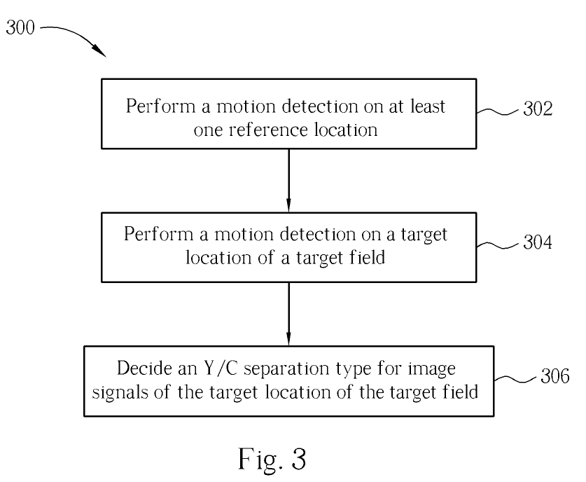

FIG. 3 depicts a flowchart 300 illustrating how the Y/C separating device 100 performs a Y/C separation on the image signals of the target location 14 of the target field 240 according to one embodiment of the present invention. The steps of the flowchart 300 are described as follows:

In step 302, the motion detector 110 performs motion detection on at least one reference location corresponding to the target location 14 so as to determine if an image surrounding the reference location is still. In this embodiment, the reference location may be one or more pixel locations located at the surrounding of the target location 14. The selected reference locations may be entirely located in either the target field 240 or a neighboring field, such as the preceding field 230. Additionally, it may be that parts of the reference locations are located in the target field 240 and other parts of the reference locations are located in a neighboring field (such as the preceding field 230). In a first embodiment, for example, two pixel locations 12 and 16 in the field 230 with respect to the vertical direction of the target location 14 are selected to be the reference locations. Accordingly, in the first embodiment, the buffer 122 further comprises a one-field delay unit and a one-line delay unit. In a second embodiment, two pixel locations 10 and 18 in the target field 240 are selected to be the reference locations. Accordingly, in the second embodiment, the buffer 122 further comprises a one-line delay and a one-pixel delay. In a third embodiment, the two pixel locations 12 and 16 of the field 230 and the two pixel locations 10 and 18 of the target field 240 are selected to be the reference locations.

The motion detector 110 could be designed to determine the degree of difference between two consecutive fields with respect to a specific pixel location or to determine the degree of difference between two successive fields of the same type (i.e., two successive odd fields or two successive even fields) with respect to a specific pixel location. For example, when the motion detector 110 performs a motion detection on the reference location 12 of the field 230, it can determine the degree of difference between the field 230 and the neighboring field 220 with respect to the pixel location 12 or determine the degree of difference between the field 230 and the field 210 of the same type with respect to the pixel location 12. In practice, the motion detector 110 could be implemented with various existing or future techniques and circuits and not be limited to any specific detection algorithm. Since the operation and implementations of the motion detector are known in the art, the further details are omitted here.

In one embodiment, if a pixel location of the field 230 is determined to have no motion, a value “0” could be accordingly recorded in the buffer to be a representative value. Conversely, if the pixel location of the field 230 is determined to have motion, then a value “1” is accordingly recorded in the buffer to be the representative value. As a result, when the Y/C separating device 100 processes the image signals of the target location 14 of the target field 240, if the selected reference location is prior to the target location 14 of the target field 240, the motion detector 110 only needs to retrieve the representative value corresponding to the reference location from the buffer so as to obtain the motion situation of the reference location without performing a duplicate detection.

In step 304, the motion detector 110 performs a motion detection on the target location 14 of the target field 240. Similarly, the motion detector 110 can determine the degree of difference between the target field 240 and the preceding field 230 with respect to the target location 14 or determine the degree of difference between the target field 240 and the field 220 of the same type with respect to the target location 14. As mentioned before, the detection result represents whether or not the image of the target location 14 of the target field 240 is in motion.

In step 306, the control logic 124 decides a type of Y/C separation suitable for the image signals of the target location 14 of the target field 240 according to the determining results of the above steps. Specifically, the control logic 124 utilizes the determining result of step 302 to verify the correctness of the determining result of step 304. In this embodiment, if the target location 14 of the target field 240 and the selected reference locations are all determined to have no motion, then the control logic 124 determines that the image corresponding to the target location 14 of the target field 240 is still. Accordingly, the control logic 124 outputs a first control signal to control the inter-field Y/C separator 135 of the filter module 130 to perform an inter-field Y/C separation on the image signals of the target location 14 of the target field 240. That is the inter-field Y/C separator 135 performs the Y/C separation on the image signals of the target location 14 of the target field 240 by using image signals of another field with respect to the target location 14. In this embodiment, the inter-field Y/C separator 135 can be implemented with a 3D-comb filter 136.

On the other hand, if any one of the target location 14 of the target field 240 and the selected reference locations is determined to have motion, then the control logic 124 outputs a second control signal to control the intra-field Y/C separator 131 of the filter module 130 to perform an intra-field Y/C separation on the image signals of the target location 14 of the target field 240. That is the intra-field Y/C separator 131 performs the Y/C separation on the image signals of the target location 14 of the target field 240 by using image signals of another location of the target field 240. In this embodiment, the intra-field Y/C separator 131 can be implemented with a 1D-comb filter 132, a 2D-comb filter 134, or a cooperation of the 1D-comb filter 132 and the 2D-comb filter 134.

In another embodiment, the comb filters 132, 134 and 136 of the filter module 130 are respectively employed to perform Y/C separation and a blending unit (not shown) is then used for weighted-blending the operation results of the comb filters 132, 134 and 136 to obtain an output of the Y/C separating device 100 under the control of the control logic 124. Additionally, in practice, the filter module 130 further comprises a multiplexer (not shown) for selecting which type of Y/C separation needs to be performed or for selecting which result of the respective comb filters needs to be outputted under the control of the control logic 124.

As in the aforementioned descriptions, the Y/C separation method of the present invention needs to perform the motion detection on not only the target location 14 of the target field 240 but also on at least one reference location in order to verify the detection result of the target location 14 using the detection result of the reference location. However, as long as the necessary detection results previously obtained by the motion detector 110 are recorded in the buffer 122, no duplicate motion detections of the reference locations are required. In other words, the Y/C separation method of the present invention is capable of significantly reducing the chance of erroneously determining a motion area to be still without performing additional motion detection, so that the accuracy of the Y/C separation and image quality of the processed video data are thereby improved.

Please note that the above-mentioned embodiments illustrate rather than limit the invention. It should be appreciated by those of ordinary skill in the art that the number of the reference location selected in step 302 is not limited to a specific number; furthermore any pixel location, which can be used to verify the correctness of the motion detection of the target location 14 of the target field 240, can be employed as the reference location in step 302. Additionally, the order of the above steps 302 and 304 is merely an embodiment and not a restriction of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for separating luminance (Y) and chrominance (C) of a composite video signal, comprising:
performing a motion detection on a target location of a target field;
performing a motion detection on at least one reference location; and
if the reference location and the target location are determined to have no motion, performing an inter-field Y/C separation on image data of the target location.

2. The method of claim 1, wherein the reference locations are located in the surrounding of the target location.

3. The method of claim 2, wherein the reference locations are located in the target field.

4. The method of claim 2, wherein the reference locations are located in a field preceding the target field.

5. The method of claim 2, wherein parts of the reference locations are located in the target field and other parts of the reference locations are located in a field preceding the target field.

6. The method of claim 1, wherein the step of performing the inter-field Y/C separation further comprises:
performing a 3D-comb filtering on the image data of the target location.

7. The method of claim 1, further comprising:
if any one of the reference locations and target location is determined to have motion, performing an intra-field Y/C separation on the image data of the target location.

8. The method of claim 7, wherein the step of performing the intra-field Y/C separation further comprises:
performing at least one of a 1D comb filtering and a 2D comb filtering on the image data of the target location.

9. The method of claim 7, wherein the step of performing the intra-field Y/C separation further comprises:
respectively performing a 1D-comb filtering, a 2D-comb filtering and a 3D-comb filtering on the image data of the target location; and
separating luminance and chrominance from the image data of the target location according to a weighted-blinding of the 1D, 2D, and 3D comb filtering operations.

10. An apparatus for separating a composite video signal, comprising:
a motion detector for performing motion detection on a target location of a target field of the composite video signal and on at least one reference location;
a decision unit coupled to the motion detector, for generating a control signal according to the detection results of the target location and the reference location; and
a Y/C separation module comprising an inter-field Y/C separator and an intra-field Y/C separator, the Y/C separation module for selecting one of the inter-field and the intra-field Y/C separators to separate luminance (Y) and chrominance (C) of image data of the target location of the composite video signal according to the control signal.

11. The apparatus of claim 10, wherein the reference locations are located in the surrounding of the target location.

12. The apparatus of claim 11, wherein the reference locations are located in the target field.

13. The apparatus of claim 11, wherein the reference locations are located in a field preceding the target field.

14. The apparatus of claim 11, wherein parts of the reference locations are located in the target field and other parts of the reference locations are located in a field preceding the target field.

15. The apparatus of claim 10, wherein the inter-field Y/C separator comprises a 3D-comb filter.

16. The apparatus of claim 10, wherein the intra-field Y/C separator comprises at least one of a 1D-comb filter and a 2D-comb filter.

17. The apparatus of claim 10, wherein the Y/C separating apparatus is used in a video decoder.

18. The apparatus of claim 10, wherein the decision unit comprises:
a buffer for temporarily storing at least one detection result from the motion detector; and
a control logic, coupled to the buffer and the motion detector, for generating the control signal according to the detection results of the motion detector.

19. The apparatus of claim 10, wherein the decision unit comprises:
a buffer for temporarily storing at least one detection result from the motion detector to output at least one of a one-line delayed detection result and a one-field delayed detection result.

20. The apparatus of claim 10, further comprising:
a de-composite unit for receiving and separating the composite video signal and outputting either Y data or C data to the motion detector.
